(19) United States
(12) Patent Application Publication
(10) Pub. No.: US 2026/0239105 A1
(43) Pub. Date: Aug. 13, 2026

(54) SIGNALING AND DETERMINING IDLE PERIODS DURING REAL-TIME TRAFFIC COMMUNICATION

(71) Applicant: QUALCOMM Incorporated, San Diego, CA (US)

(72) Inventors: Liangping Ma, San Diego, CA (US); Thomas Stockhammer, Bergen (DE); Imed Bouazizi, Celina, TX (US)

(21) Appl. No.: 19/425,463

(22) Filed: Dec. 18, 2025

Related U.S. Application Data
(60) Provisional application No. 63/756,858, filed on Feb. 11, 2025.

(51) Int. Cl. H04W 28/06; H04L 5/00; H04L 69/22; H04W 52/02

(52) U.S. Cl. CPC H04W 28/06; H04L 5/0048; H04L 69/22; H04W 52/0238

(57) ABSTRACT

An example device for receiving data via a network includes a processing system implemented in circuitry, the processing system comprising reception circuitry configured to receive packets including media data and one or more processors implemented in circuitry, the processing system being configured to: receive, via the reception circuitry, data representing a lower bound on a time between a time of transmission of a previous packet and a time of transmission of a subsequent packet; after receiving the previous packet, disable the reception circuitry for an idle time period according to the data representing the lower bound on the time between the time of transmission of the previous packet and the time of transmission of the subsequent packet; after the idle time period, enable the reception circuitry; and after enabling the reception circuitry, receive, via the reception circuitry, the subsequent packet.

This application claims the benefit of U.S. Provisional Application No. 63/756,858, filed Feb. 11, 2025, the entire contents of which are hereby incorporated by reference.

### TECHNICAL FIELD

This disclosure relates to transport of media data.

### BACKGROUND

Digital video capabilities can be incorporated into a wide range of devices, including digital televisions, digital direct broadcast systems, wireless broadcast systems, personal digital assistants (PDAs), laptop or desktop computers, digital cameras, digital recording devices, digital media players, video gaming devices, video game consoles, cellular or satellite radio telephones, video teleconferencing devices, and the like. Digital video devices implement video compression techniques, such as those described in the standards defined by MPEG-2, MPEG-4, ITU-T H.263 or ITU-T H.264/MPEG-4, Part 10, Advanced Video Coding (AVC), ITU-T H.265 (also referred to as High Efficiency Video Coding (HEVC)), and extensions of such standards, to transmit and receive digital video information more efficiently.

Video compression techniques perform spatial prediction and/or temporal prediction to reduce or remove redundancy inherent in video sequences. For block-based video coding, a video frame or slice may be partitioned into macroblocks. Each macroblock can be further partitioned. Macroblocks in an intra-coded (I) frame or slice are encoded using spatial prediction with respect to neighboring macroblocks. Macroblocks in an inter-coded (P or B) frame or slice may use spatial prediction with respect to neighboring macroblocks in the same frame or slice or temporal prediction with respect to other reference frames.

After video data has been encoded, the video data may be packetized for transmission or storage. The video data may be assembled into a video file conforming to any of a variety of standards, such as the International Organization for Standardization (ISO) base media file format and extensions thereof, such as AVC.

### SUMMARY

In general, this disclosure describes techniques for exchanging data via a network, such as media data. The network may be a radio access network (RAN), such as a 5G network. Media data, such as video data, may take variable amounts of time to encode and transmit. For example, a frame of video data following a scene change may require more time to encode than a frame of video data following another frame of the same scene. Thus, predicting precise timing between packets of data sent via the network may be difficult when the packets include frames of video data. Therefore, rather than signaling a precise time to next burst (TTNB) value, the techniques of this disclosure include signaling a minimum or a lower bound on a time between a time of transmission of a previous packet and a time of transmission of a subsequent packet.

In this manner, the sender may determine a minimum or a lower bound on the amount of time required to, e.g., encode and send packets corresponding to various frames of video data and signal this minimum or a lower bound on the amount of time. Therefore, a client device or other receiving device may deactivate reception circuitry to save power, while also ensuring that the reception circuitry is active at the time required to receive the subsequent packet. As such, signaled times between packets may be reduced, thereby reducing latency for transmissions, while also preserving the ability of the client device to save power between packet transmissions.

In one example, a method of receiving data via a network includes: receiving data representing a lower bound on a time between a time of transmission of a previous packet and a time of transmission of a subsequent packet; after receiving the previous packet, disabling reception of data for an idle time period according to the data representing the lower bound on the time between the time of transmission of the previous packet and the time of transmission of the subsequent packet; after the idle time period, enabling reception of data; and after enabling reception of data, receiving the subsequent packet.

In another example, a device for receiving media data includes: a memory configured to store media data; and a processing system implemented in circuitry, the processing system comprising reception circuitry configured to receive packets including media data and one or more processors implemented in circuitry, the processing system being configured to: receive, via the reception circuitry, data representing a lower bound on a time between a time of transmission of a previous packet and a time of transmission of a subsequent packet; after receiving the previous packet, disable the reception circuitry for an idle time period according to the data representing the lower bound on the time between the time of transmission of the previous packet and the time of transmission of the subsequent packet; after the idle time period, enable the reception circuitry; and after enabling the reception circuitry, receive, via the reception circuitry, the subsequent packet.

In another example, a method of sending data via a network includes: sending a previous packet of a packet flow to a client device; determining a minimum time between a time of transmission of the previous packet and a time of transmission of a subsequent packet of the packet flow; sending data representing the lower bound on the time between the time of transmission of the previous packet and the time of transmission of the subsequent packet to the client device; and at or after a time corresponding to the lower bound on the time following the time of transmission of the previous packet, sending the subsequent packet to the client device.

The details of one or more examples are set forth in the accompanying drawings and the description below. Other features, objects, and advantages will be apparent from the description and drawings, and from the claims.

### BRIEF DESCRIPTION OF DRAWINGS

FIG. 1 is a block diagram illustrating an example system that implements techniques for streaming media data over a network.

FIG. 2 is a block diagram illustrating elements of an example video file.

FIG. 3 is a conceptual diagram illustrating an example definition of an idle period per techniques of this disclosure.

FIG. 4 is a conceptual diagram illustrating another example definition for an idle period per techniques of this disclosure.

FIG. 5 is a conceptual diagram illustrating another example definition of an idle period per techniques of this disclosure.

FIG. 6 is a conceptual diagram illustrating transmission of packets from a traffic source (e.g., an application server (AS) device), a routing device, and a user plane function (UPF) device.

FIG. 7 is a block diagram illustrating an example set of network devices that may perform various aspects of the techniques of this disclosure.

FIG. 8 is a flowchart illustrating an example method of sending media data via a network according to the techniques of this disclosure.

FIG. 9 is a flowchart illustrating an example method of receiving media data via a network according to the techniques of this disclosure.

### DETAILED DESCRIPTION

In general, this disclosure describes techniques for transmitting data via a network, such as a radio access network (RAN). In some conventional techniques, a time to next burst (TTNB) value represents a time interval between transmission of a last packet in a current burst and a first packet of a next burst, i.e., inter-burst time. However, this disclosure recognizes that this definition of TTNB may result in problems in some cases. For example, when transmitting live video data (i.e., video data being recorded in real time), the video encoding time can be highly variable and rate adaptation can change a time when the next frame can be generated. Furthermore, it is difficult for the sending device to determine precisely when the first packet of the next burst will be created.

This disclosure describes techniques that may be used to address timing uncertainty at the sending device side due to application layer behavior (e.g., multimedia encoding, congestion control, and/or rate control). Per techniques of this disclosure, an idle period (i.e., a time between transmission of data bursts) may be defined that is more general than the conventional TTNB value. In some examples, per the techniques of this disclosure, the TTNB value may represent a time interval between transmission of an ordinal last protocol data unit (PDU) in a current data burst and a time instant that is earlier than or equal to the transmission of an ordinal first PDU of a next data burst. Attributes for data bursts may include burst identifiers, and the idle period concept of this disclosure may be used without the context of a data burst. For example, if a data burst is relatively long, e.g., 6 ms, the idle period may signal a time gap within the data burst, which can help with client device (e.g., user equipment (UE) device) power saving. For TTNB, the idle period may be particularized to retain the ability to handle timing uncertainty.

Per techniques of this disclosure, an idle period may be defined as a time period during which the sending device will not send any packet, where the starting point of the idle time period may be the time of transmission of the packet that carries the idle period indication. The idle period may therefore serve as a minimum or a lower bound on the time period during which no traffic departs the sending device. Thus, it is possible that the sending device may continue to refrain from sending traffic after the idle period. The idle period may be applied to data bursts to redefine the conventional TTNB value, such that, rather than a precise time between transmission of previous packet and subsequent packet, a redefined TTNB value per these techniques is the minimum or a lower bound on the amount of time to be elapsed from the transmission of the last packet in the current data burst to the transmission of the first packet of the next burst.

In some examples, the signaling may further include a “start-to-render-at-time” parameter indicating a time of starting a rendering of the media data. This parameter may be used in conjunction with the idle period or TTNB value to coordinate playback and reception processes. For instance, the idle period may govern the reception circuitry power state, while the start-to-render-at-time parameter governs the presentation timing of the received media data.

Implementing a lower bound for inter-burst timing may enable receiving devices, such as user equipment (UE), to optimize power consumption while maintaining reliability. In response to receiving an indication of a lower bound or minimum idle period, a receiving device may disable reception circuitry for the duration of the indicated idle period. Because the signaled time represents a minimum duration (e.g., lower bound), the receiving device can safely re-enable reception circuitry prior to or coincident with the arrival of the subsequent packet. This approach allows the overall system (including the sending device and the receiving device, as well as other devices, such as base stations, e.g., next generation nodeB (gNodeB) devices) to accommodate variable delays between packets, such as variable video encoding delays, without risking packet loss due to the receiving device remaining idle beyond the arrival of data of the next burst.

In this manner, the idle period definition or the newly defined TTNB value may easily allow the sending device to account for delays between packets, e.g., video encoding delay, which is variable even if video frame rate is constant. For example, assuming the video encoding delay varies from 1 to 3 ms, the nominal frame rate is 60 fps, and the spread of packets of a frame is negligible, with the conventional definition of TTNB, it would be difficult for the sending device to determine when the next frame will be sent out. However, per techniques of this disclosure, the sending device may determine a maximum extra encoding delay of 2 ms and a time between frames of 16.67 ms, then signal the difference as 14.67 ms (16.67 ms-2 ms) as the minimum or lower bound on the time between packet bursts.

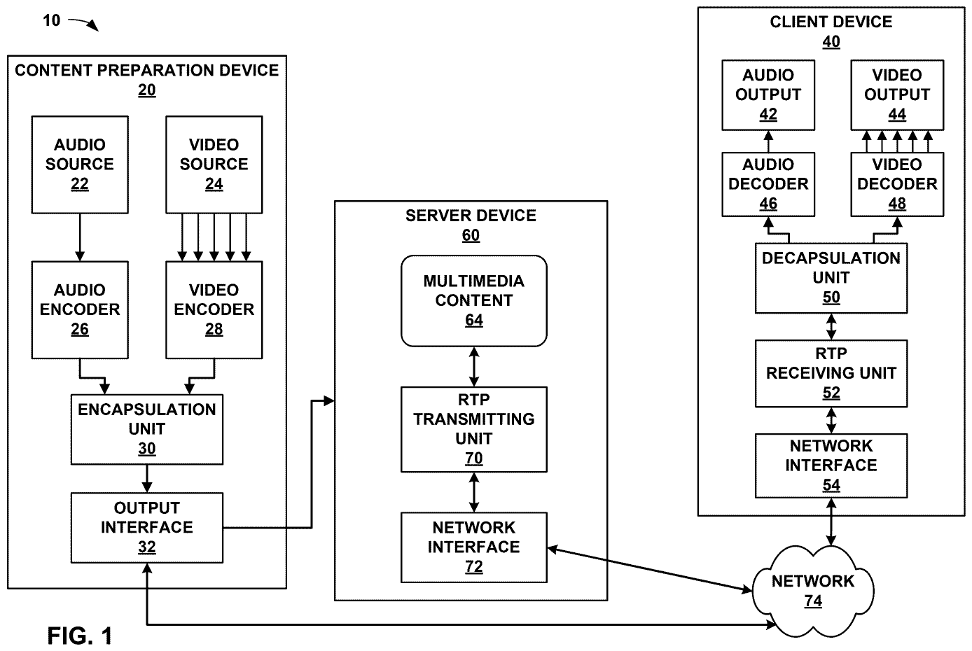

FIG. 1 is a block diagram illustrating an example system 10 that implements techniques for streaming media data over a network. In this example, system 10 includes content preparation device 20, server device 60, and client device 40. Client device 40 and server device 60 are communicatively coupled by network 74, which may comprise the Internet. In some examples, content preparation device 20 and server device 60 may also be coupled by network 74 or another network, or may be directly communicatively coupled. In some examples, content preparation device 20 and server device 60 may comprise the same device.

Content preparation device 20, in the example of FIG. 1, comprises audio source 22 and video source 24. Audio source 22 may comprise, for example, a microphone that produces electrical signals representative of captured audio data to be encoded by audio encoder 26. Alternatively, audio source 22 may comprise a storage medium storing previously recorded audio data, an audio data generator such as a computerized synthesizer, or any other source of audio data. Video source 24 may comprise a video camera that produces video data to be encoded by video encoder 28, a storage medium encoded with previously recorded video data, a video data generation unit such as a computer graphics source, or any other source of video data. Content preparation device 20 is not necessarily communicatively coupled to server device 60 in all examples, but may store multimedia content to a separate medium that is read by server device 60.

Raw audio and video data may comprise analog or digital data. Analog data may be digitized before being encoded by audio encoder 26 and/or video encoder 28. Audio source 22 may obtain audio data from a speaking participant while the speaking participant is speaking, and video source 24 may simultaneously obtain video data of the speaking participant. In other examples, audio source 22 may comprise a computer-readable storage medium comprising stored audio data, and video source 24 may comprise a computer-readable storage medium comprising stored video data. In this manner, the techniques described in this disclosure may be applied to live, streaming, real-time audio and video data or to archived, pre-recorded audio and video data.

Audio frames that correspond to video frames are generally audio frames containing audio data that was captured (or generated) by audio source 22 contemporaneously with video data captured (or generated) by video source 24 that is contained within the video frames. For example, while a speaking participant generally produces audio data by speaking, audio source 22 captures the audio data, and video source 24 captures video data of the speaking participant at the same time, that is, while audio source 22 is capturing the audio data. Hence, an audio frame may temporally correspond to one or more particular video frames. Accordingly, an audio frame corresponding to a video frame generally corresponds to a situation in which audio data and video data were captured at the same time and for which an audio frame and a video frame comprise, respectively, the audio data and the video data that was captured at the same time.

In some examples, audio encoder 26 may encode a timestamp in each encoded audio frame that represents a time at which the audio data for the encoded audio frame was recorded, and similarly, video encoder 28 may encode a timestamp in each encoded video frame that represents a time at which the video data for an encoded video frame was recorded. In such examples, an audio frame corresponding to a video frame may comprise an audio frame comprising a timestamp and a video frame comprising the same timestamp. Content preparation device 20 may include an internal clock from which audio encoder 26 and/or video encoder 28 may generate the timestamps, or that audio source 22 and video source 24 may use to associate audio and video data, respectively, with a timestamp.

In some examples, audio source 22 may send data to audio encoder 26 corresponding to a time at which audio data was recorded, and video source 24 may send data to video encoder 28 corresponding to a time at which video data was recorded. In some examples, audio encoder 26 may encode a sequence identifier in encoded audio data to indicate a relative temporal ordering of encoded audio data but without necessarily indicating an absolute time at which the audio data was recorded, and similarly, video encoder 28 may also use sequence identifiers to indicate a relative temporal ordering of encoded video data. Similarly, in some examples, a sequence identifier may be mapped or otherwise correlated with a timestamp.

Audio encoder 26 generally produces a stream of encoded audio data, while video encoder 28 produces a stream of encoded video data. Each individual stream of data (whether audio or video) may be referred to as an elementary stream. An elementary stream is a single, digitally coded (possibly compressed) component of a media presentation. For example, the coded video or audio part of the media presentation can be an elementary stream. An elementary stream may be converted into a packetized elementary stream (PES) before being encapsulated within a video file. Within the same media presentation, a stream ID may be used to distinguish the PES-packets belonging to one elementary stream from the other. The basic unit of data of an elementary stream is a packetized elementary stream (PES) packet. Thus, coded video data generally corresponds to elementary video streams. Similarly, audio data corresponds to one or more respective elementary streams.

In the example of FIG. 1, encapsulation unit 30 of content preparation device 20 receives elementary streams comprising coded video data from video encoder 28 and elementary streams comprising coded audio data from audio encoder 26. In some examples, video encoder 28 and audio encoder 26 may each include packetizers for forming PES packets from encoded data. In other examples, video encoder 28 and audio encoder 26 may each interface with respective packetizers for forming PES packets from encoded data. In still other examples, encapsulation unit 30 may include packetizers for forming PES packets from encoded audio and video data.

Video encoder 28 may encode video data of multimedia content in a variety of ways, to produce different representations of the multimedia content at various bitrates and with various characteristics, such as pixel resolutions, frame rates, conformance to various coding standards, conformance to various profiles and/or levels of profiles for various coding standards, representations having one or multiple views (e.g., for two-dimensional or three-dimensional playback), or other such characteristics. A representation, as used in this disclosure, may comprise one of audio data, video data, text data (e.g., for closed captions), or other such data. The representation may include an elementary stream, such as an audio elementary stream or a video elementary stream. Each PES packet may include a stream_id that identifies the elementary stream to which the PES packet belongs. Encapsulation unit 30 is responsible for assembling elementary streams into streamable media data.

Encapsulation unit 30 receives PES packets for elementary streams of a media presentation from audio encoder 26 and video encoder 28 and forms corresponding network abstraction layer (NAL) units from the PES packets. Coded video segments may be organized into NAL units, which provide a “network-friendly” video representation addressing applications such as video telephony, storage, broadcast, or streaming. NAL units can be categorized to Video Coding Layer (VCL) NAL units and non-VCL NAL units. VCL units may contain the core compression engine and may include block, macroblock, and/or slice level data. Other NAL units may be non-VCL NAL units. In some examples, a coded picture in one time instance, normally presented as a primary coded picture, may be contained in an access unit, which may include one or more NAL units.

Non-VCL NAL units may include parameter set NAL units and SEI NAL units, among others. Parameter sets may contain sequence-level header information (in sequence parameter sets (SPS)) and the infrequently changing picture-level header information (in picture parameter sets (PPS)). With parameter sets (e.g., PPS and SPS), infrequently changing information need not be repeated for each sequence or picture; hence, coding efficiency may be improved. Furthermore, the use of parameter sets may enable out-of-band transmission of the important header information, avoiding the need for redundant transmissions for error resilience. In out-of-band transmission examples, parameter set NAL units may be transmitted on a different channel than other NAL units, such as SEI NAL units.

Supplemental Enhancement Information (SEI) may contain information that is not necessary for decoding the coded pictures samples from VCL NAL units, but may assist in processes related to decoding, display, error resilience, and other purposes. SEI messages may be contained in non-VCL NAL units. SEI messages are the normative part of some standard specifications, and thus are not always mandatory for standard compliant decoder implementation. SEI messages may be sequence level SEI messages or picture level SEI messages. Some sequence level information may be contained in SEI messages, such as scalability information SEI messages in the example of scalable video coding (SVC) and view scalability information SEI messages in multiview video coding (MVC). These example SEI messages may convey information on, e.g., extraction of operation points and characteristics of the operation points.

Server device 60 includes Real-time Transport Protocol (RTP) transmitting unit 70 and network interface 72. In some examples, server device 60 may include a plurality of network interfaces. Furthermore, any or all of the features of server device 60 may be implemented on other devices of a content delivery network, such as routers, bridges, proxy devices, switches, or other devices. In some examples, intermediate devices of a content delivery network may cache data of multimedia content 64 and include components that conform substantially to those of server device 60. In general, network interface 72 is configured to send and receive data via network 74.

RTP transmitting unit 70 is configured to deliver media data to client device 40 via network 74 according to RTP, which is standardized in Request for Comment (RFC) 3550 by the Internet Engineering Task Force (IETF). RTP transmitting unit 70 may also implement protocols related to RTP, such as RTP Control Protocol (RTCP), Real-time Streaming Protocol (RTSP), Session Initiation Protocol (SIP), and/or Session Description Protocol (SDP). RTP transmitting unit 70 may send media data via network interface 72, which may implement Uniform Datagram Protocol (UDP) and/or Internet protocol (IP). Thus, in some examples, server device 60 may send media data via RTP and RTSP over UDP using network 74.

RTP transmitting unit 70 may receive an RTSP describe request from, e.g., client device 40. The RTSP describe request may include data indicating what types of data are supported by client device 40. RTP transmitting unit 70 may respond to client device 40 with data indicating media streams, such as media content 64, that can be sent to client device 40, along with a corresponding network location identifier, such as a uniform resource locator (URL) or uniform resource name (URN).

RTP transmitting unit 70 may then receive an RTSP setup request from client device 40. The RTSP setup request may generally indicate how a media stream is to be transported. The RTSP setup request may contain the network location identifier for the requested media data (e.g., media content 64) and a transport specifier, such as local ports for receiving RTP data and control data (e.g., RTCP data) on client device 40. RTP transmitting unit 70 may reply to the RTSP setup request with a confirmation and data representing ports of server device 60 by which the RTP data and control data will be sent. RTP transmitting unit 70 may then receive an RTSP play request, to cause the media stream to be “played,” i.e., sent to client device 40 via network 74. RTP transmitting unit 70 may also receive an RTSP teardown request to end the streaming session, in response to which, RTP transmitting unit 70 may stop sending media data to client device 40 for the corresponding session.

RTP receiving unit 52, likewise, may initiate a media stream by initially sending an RTSP describe request to server device 60. The RTSP describe request may indicate types of data supported by client device 40. RTP receiving unit 52 may then receive a reply from server device 60 specifying available media streams, such as media content 64, that can be sent to client device 40, along with a corresponding network location identifier, such as a uniform resource locator (URL) or uniform resource name (URN).

RTP receiving unit 52 may then generate an RTSP setup request and send the RTSP setup request to server device 60. As noted above, the RTSP setup request may contain the network location identifier for the requested media data (e.g., media content 64) and a transport specifier, such as local ports for receiving RTP data and control data (e.g., RTCP data) on client device 40. In response, RTP receiving unit 52 may receive a confirmation from server device 60, including ports of server device 60 that server device 60 will use to send media data and control data.

After establishing a media streaming session between server device 60 and client device 40, RTP transmitting unit 70 of server device 60 may send media data (e.g., packets of media data) to client device 40 according to the media streaming session. Server device 60 and client device 40 may exchange control data (e.g., RTCP data) indicating, for example, reception statistics by client device 40, such that server device 60 can perform congestion control or otherwise diagnose and address transmission faults.

In accordance with techniques of this disclosure, RTP transmitting unit 70 may determine a sequence of packets forming a data burst comprising encoded video data from video encoder 28. To assist client device 40 with power management, RTP transmitting unit 70 may calculate an idle period representing a minimum duration or a lower bound on a time interval between transmission of a last packet of the current data burst and transmission of a first packet of a subsequent data burst. Unlike a precise time-to-next-burst (TTNB) value that attempts to predict an exact arrival time, this lower bound may account for variable encoding delays associated with video encoder 28 (e.g., due to scene changes or rate control) and/or network jitter within network 74. In some examples, per the techniques of this disclosure, the TTNB value may represent a time interval between transmission of an ordinal last protocol data unit (PDU) in a current data burst and a time instant that is earlier than or equal to the transmission of an ordinal first PDU of a next data burst. RTP transmitting unit 70 may signal this idle period in a header extension of an RTP packet, such as the last packet of the current data burst sent via network interface 72.

In response to receiving an RTP packet containing an idle period indication in an RTP header extension via network interface 54, client device 40 may parse the RTP header extension to determine the minimum duration during which server device 60 will not transmit data for the media stream. Network interface 54 or other reception circuitry of client device 40 may enter a low-power or sleep mode for a duration corresponding to the signaled idle period. Because the signaled value represents a lower bound (a time instant earlier than or equal to the transmission of the next burst), client device 40 enables or reactivates the reception circuitry at or before the expiration of the idle period. This ensures client device 40 is active to receive the first packet of the subsequent data burst, thereby reducing power consumption without risking data loss due to timing variations at server device 60.

Alternatively, when client device 40 is a user equipment (UE) device, rather than client device 40 parsing the RTP header extension, a base station (not shown in FIG. 1), such as a gNodeB, may receive and parse the RTP header extension. The base station may then configure client device 40 to enter a low-power or sleep mode for a duration corresponding to the signaled idle period, based on the data of the RTP header extension.

Network interface 54 may receive and provide media of a selected media presentation to RTP receiving unit 52, which may in turn provide the media data to decapsulation unit 50. Decapsulation unit 50 may decapsulate elements of a video file into constituent PES streams, depacketize the PES streams to retrieve encoded data, and send the encoded data to either audio decoder 46 or video decoder 48, depending on whether the encoded data is part of an audio or video stream, e.g., as indicated by PES packet headers of the stream. Audio decoder 46 decodes encoded audio data and sends the decoded audio data to audio output 42, while video decoder 48 decodes encoded video data and sends the decoded video data, which may include a plurality of views of a stream, to video output 44.

Video encoder 28, video decoder 48, audio encoder 26, audio decoder 46, encapsulation unit 30, RTP receiving unit 52, and decapsulation unit 50 each may be implemented as any of a variety of suitable processing circuitry, as applicable, such as one or more microprocessors, digital signal processors (DSPs), application specific integrated circuits (ASICs), field programmable gate arrays (FPGAs), discrete logic circuitry, software, hardware, firmware or any combinations thereof. Each of video encoder 28 and video decoder 48 may be included in one or more encoders or decoders, either of which may be integrated as part of a combined video encoder/decoder (CODEC). Likewise, each of audio encoder 26 and audio decoder 46 may be included in one or more encoders or decoders, either of which may be integrated as part of a combined CODEC. An apparatus including video encoder 28, video decoder 48, audio encoder 26, audio decoder 46, encapsulation unit 30, RTP receiving unit 52, and/or decapsulation unit 50 may comprise an integrated circuit, a microprocessor, and/or a wireless communication device, such as a cellular telephone.

Client device 40, server device 60, and/or content preparation device 20 may be configured to operate in accordance with the techniques of this disclosure. For purposes of example, this disclosure describes these techniques with respect to client device 40 and server device 60. However, it should be understood that content preparation device 20 may be configured to perform these techniques, instead of (or in addition to) server device 60.

Encapsulation unit 30 may form NAL units comprising a header that identifies a program to which the NAL unit belongs, as well as a payload, e.g., audio data, video data, or data that describes the transport or program stream to which the NAL unit corresponds. For example, in H.264/AVC, a NAL unit includes a 1-byte header and a payload of varying size. A NAL unit including video data in its payload may comprise various granularity levels of video data. For example, a NAL unit may comprise a block of video data, a plurality of blocks, a slice of video data, or an entire picture of video data. Encapsulation unit 30 may receive encoded video data from video encoder 28 in the form of PES packets of elementary streams. Encapsulation unit 30 may associate each elementary stream with a corresponding program.

Encapsulation unit 30 may also assemble access units from a plurality of NAL units. In general, an access unit may comprise one or more NAL units for representing a frame of video data, as well as audio data corresponding to the frame when such audio data is available. An access unit generally includes all NAL units for one output time instance, e.g., all audio and video data for one time instance. For example, if each view has a frame rate of 20 frames per second (fps), then each time instance may correspond to a time interval of 0.05 seconds. During this time interval, the specific frames for all views of the same access unit (the same time instance) may be rendered simultaneously. In one example, an access unit may comprise a coded picture in one time instance, which may be presented as a primary coded picture.

Accordingly, an access unit may comprise all audio and video frames of a common temporal instance, e.g., all views corresponding to time X. This disclosure also refers to an encoded picture of a particular view as a “view component.” That is, a view component may comprise an encoded picture (or frame) for a particular view at a particular time. Accordingly, an access unit may be defined as comprising all view components of a common temporal instance. The decoding order of access units need not necessarily be the same as the output or display order.

After encapsulation unit 30 has assembled NAL units and/or access units into a video file based on received data, encapsulation unit 30 passes the video file to output interface 32 for output. In some examples, encapsulation unit 30 may store the video file locally or send the video file to a remote server via output interface 32, rather than sending the video file directly to client device 40. Output interface 32 may comprise, for example, a transmitter, a transceiver, a device for writing data to a computer-readable medium such as, for example, an optical drive, a magnetic media drive (e.g., floppy drive), a universal serial bus (USB) port, a network interface, or other output interface. Output interface 32 outputs the video file to a computer-readable medium, such as, for example, a transmission signal, a magnetic medium, an optical medium, a memory, a flash drive, or other computer-readable medium.

Network interface 54 may receive a NAL unit or access unit via network 74 and provide the NAL unit or access unit to decapsulation unit 50, via RTP receiving unit 52. Decapsulation unit 50 may decapsulate elements of a video file into constituent PES streams, depacketize the PES streams to retrieve encoded data, and send the encoded data to either audio decoder 46 or video decoder 48, depending on whether the encoded data is part of an audio or video stream, e.g., as indicated by PES packet headers of the stream. Audio decoder 46 decodes encoded audio data and sends the decoded audio data to audio output 42, while video decoder 48 decodes encoded video data and sends the decoded video data, which may include a plurality of views of a stream, to video output 44.

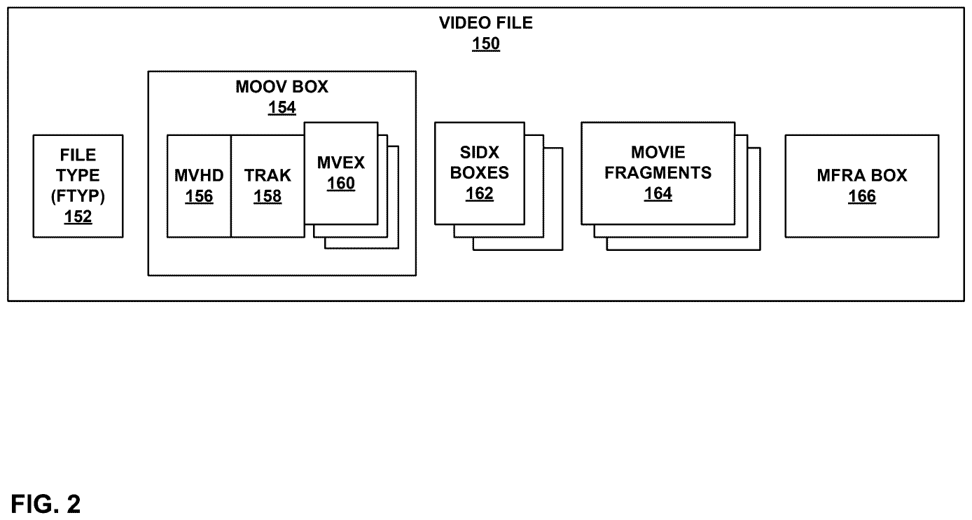

FIG. 2 is a block diagram illustrating elements of an example video file 150. As described above, video files in accordance with the ISO base media file format and extensions thereof store data in a series of objects, referred to as “boxes.” In the example of FIG. 2, video file 150 includes file type (FTYP) box 152, movie (MOOV) box 154, segment index (sidx) boxes 162, movie fragment (MOOF) boxes 164, and movie fragment random access (MFRA) box 166. Although FIG. 2 represents an example of a video file, it should be understood that other media files may include other types of media data (e.g., audio data, timed text data, or the like) that is structured similarly to the data of video file 150, in accordance with the ISO base media file format and its extensions.

File type (FTYP) box 152 generally describes a file type for video file 150. File type box 152 may include data that identifies a specification that describes a best use for video file 150. File type box 152 may alternatively be placed before MOOV box 154, movie fragment boxes 164, and/or MFRA box 166.

MOOV box 154, in the example of FIG. 2, includes movie header (MVHD) box 156, track (TRAK) box 158, and one or more movie extends (MVEX) boxes 160. In general, MVHD box 156 may describe general characteristics of video file 150. For example, MVHD box 156 may include data that describes when video file 150 was originally created, when video file 150 was last modified, a timescale for video file 150, a duration of playback for video file 150, or other data that generally describes video file 150.

TRAK box 158 may include data for a track of video file 150. TRAK box 158 may include a track header (TKHD) box that describes characteristics of the track corresponding to TRAK box 158. In some examples, TRAK box 158 may include coded video pictures, while in other examples, the coded video pictures of the track may be included in movie fragments 164, which may be referenced by data of TRAK box 158 and/or sidx boxes 162.

In some examples, video file 150 may include more than one track. Accordingly, MOOV box 154 may include a number of TRAK boxes equal to the number of tracks in video file 150. TRAK box 158 may describe characteristics of a corresponding track of video file 150. For example, TRAK box 158 may describe temporal and/or spatial information for the corresponding track. A TRAK box similar to TRAK box 158 of MOOV box 154 may describe characteristics of a parameter set track, when encapsulation unit 30 (FIG. 1) includes a parameter set track in a video file, such as video file 150. Encapsulation unit 30 may signal the presence of sequence level SEI messages in the parameter set track within the TRAK box describing the parameter set track.

MVEX boxes 160 may describe characteristics of corresponding movie fragments 164, e.g., to signal that video file 150 includes movie fragments 164, in addition to video data included within MOOV box 154, if any. In the context of streaming video data, coded video pictures may be included in movie fragments 164 rather than in MOOV box 154. Accordingly, all coded video samples may be included in movie fragments 164, rather than in MOOV box 154.

MOOV box 154 may include a number of MVEX boxes 160 equal to the number of movie fragments 164 in video file 150. Each of MVEX boxes 160 may describe characteristics of a corresponding one of movie fragments 164. For example, each MVEX box may include a movie extends header box (MEHD) box that describes a temporal duration for the corresponding one of movie fragments 164.

As noted above, encapsulation unit 30 may store a sequence data set in a video sample that does not include actual coded video data. A video sample may generally correspond to an access unit, which is a representation of a coded picture at a specific time instance. In the context of AVC, the coded picture include one or more VCL NAL units, which contain the information to construct all the pixels of the access unit and other associated non-VCL NAL units, such as SEI messages. Accordingly, encapsulation unit 30 may include a sequence data set, which may include sequence level SEI messages, in one of movie fragments 164. Encapsulation unit 30 may further signal the presence of a sequence data set and/or sequence level SEI messages as being present in one of movie fragments 164 within the one of MVEX boxes 160 corresponding to the one of movie fragments 164.

SIDX boxes 162 are optional elements of video file 150. That is, video files conforming to the Third Generation Partnership Project (3GPP) file format, or other such file formats, do not necessarily include SIDX boxes 162. In accordance with the example of the 3GPP file format, a SIDX box may be used to identify a sub-segment of a segment (e.g., a segment contained within video file 150). The 3GPP file format defines a sub-segment as “a self-contained set of one or more consecutive movie fragment boxes with corresponding Media Data box(es) and a Media Data Box containing data referenced by a Movie Fragment Box must follow that Movie Fragment box and precede the next Movie Fragment box containing information about the same track.” The 3GPP file format also indicates that a SIDX box “contains a sequence of references to subsegments of the (sub)segment documented by the box. The referenced subsegments are contiguous in presentation time. Similarly, the bytes referred to by a Segment Index box are always contiguous within the segment. The referenced size gives the count of the number of bytes in the material referenced.”

SIDX boxes 162 generally provide information representative of one or more sub-segments of a segment included in video file 150. For instance, such information may include playback times at which sub-segments begin and/or end, byte offsets for the sub-segments, whether the sub-segments include (e.g., start with) a stream access point (SAP), a type for the SAP (e.g., whether the SAP is an instantaneous decoder refresh (IDR) picture, a clean random access (CRA) picture, a broken link access (BLA) picture, or the like), a position of the SAP (in terms of playback time and/or byte offset) in the sub-segment, and the like.

Movie fragments 164 may include one or more coded video pictures. In some examples, movie fragments 164 may include one or more groups of pictures (GOPs), each of which may include a number of coded video pictures, e.g., frames or pictures. In addition, as described above, movie fragments 164 may include sequence data sets in some examples. Each of movie fragments 164 may include a movie fragment header box (MFHD, not shown in FIG. 2). The MFHD box may describe characteristics of the corresponding movie fragment, such as a sequence number for the movie fragment. Movie fragments 164 may be included in order of sequence number in video file 150.

MFRA box 166 may describe random access points within movie fragments 164 of video file 150. This may assist with performing trick modes, such as performing seeks to particular temporal locations (i.e., playback times) within a segment encapsulated by video file 150. MFRA box 166 is generally optional and need not be included in video files, in some examples. Likewise, a client device, such as client device 40, does not necessarily need to reference MFRA box 166 to correctly decode and display video data of video file 150. MFRA box 166 may include a number of track fragment random access (TFRA) boxes (not shown) equal to the number of tracks of video file 150, or in some examples, equal to the number of media tracks (e.g., non-hint tracks) of video file 150.

In some examples, movie fragments 164 may include one or more stream access points (SAPs), such as IDR pictures. Likewise, MFRA box 166 may provide indications of locations within video file 150 of the SAPs. Accordingly, a temporal sub-sequence of video file 150 may be formed from SAPs of video file 150. The temporal sub-sequence may also include other pictures, such as P-frames and/or B-frames that depend from SAPs. Frames and/or slices of the temporal sub-sequence may be arranged within the segments such that frames/slices of the temporal sub-sequence that depend on other frames/slices of the sub-sequence can be properly decoded. For example, in the hierarchical arrangement of data, data used for prediction for other data may also be included in the temporal sub-sequence.

In accordance with the techniques of this disclosure, the samples (e.g., coded video pictures or slices) stored within movie fragments 164 may correspond to data bursts including protocol data unit (PDU) Sets described herein. Server device 60 (FIG. 1) may use size information and timing information (e.g., decoding or composition timestamps stored in track run (TRUN) boxes) associated with these samples to determine boundaries of the data burst. Furthermore, server device 60 may use this file-level information to calculate the idle period or the lower bound on the time interval to the next burst. For instance, by determining the size of one or more samples of movie fragments 164, server device 60 may estimate a transmission duration for the current burst and, based on the timestamp of a subsequent sample, calculate the minimum time gap before the transmission of the subsequent burst must occur. Server device 60 may then signal this information, e.g., in an RTP header extension of an RTP packet encapsulating all or a portion of video file 150.

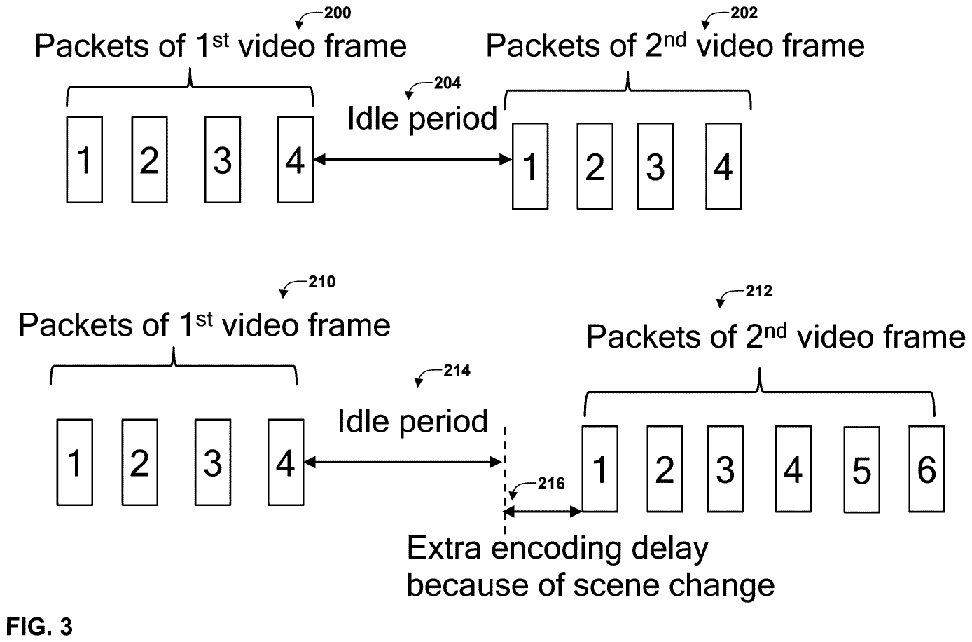

FIG. 3 is a conceptual diagram illustrating an example definition of an idle period per techniques of this disclosure. In this example, for a first set of frames including packets of first video frame 200 and packets of second video frame 202, the first and second frames each include four respective packets for transmission. Idle period 204 represents the amount of time between transmission of an ordinal last packet of first video frame 200 and an ordinal first packet of second video frame 202.

However, for a second set of packets (including packets of first video frame 210 and packets of second video frame 212), there is extra encoding delay 216 (e.g., due to a scene change) unknown to the sender at the time of idle period 214 indicated in the ordinal last packet of first video frame 210, in this example. Thus, by signaling the idle period as a minimum or lower bound on the time between packets of different data bursts, e.g., frames, a client device can disable reception for the idle period and then re-enable reception and successfully receive the packets of the next frames.

Additionally, a packet before the ordinal last packet of first video frame 210, e.g., packet 3, may indicate a time gap to the ordinal last packet of first video frame 210. This may be useful to the base station, in order for the base station to determine when to let the UE go to sleep if the last packet of first video frame 210 gets lost, because the base station can derive the time when the last packet should arrive based on the arrival time of packet 3 and the indicated time gap. If the last packet does not arrive by then plus a time margin, the base station can conclude that the last packet is lost, and safely let the UE to go to sleep. More than one packet can carry the idle period and a time gap to increase the error resilience.

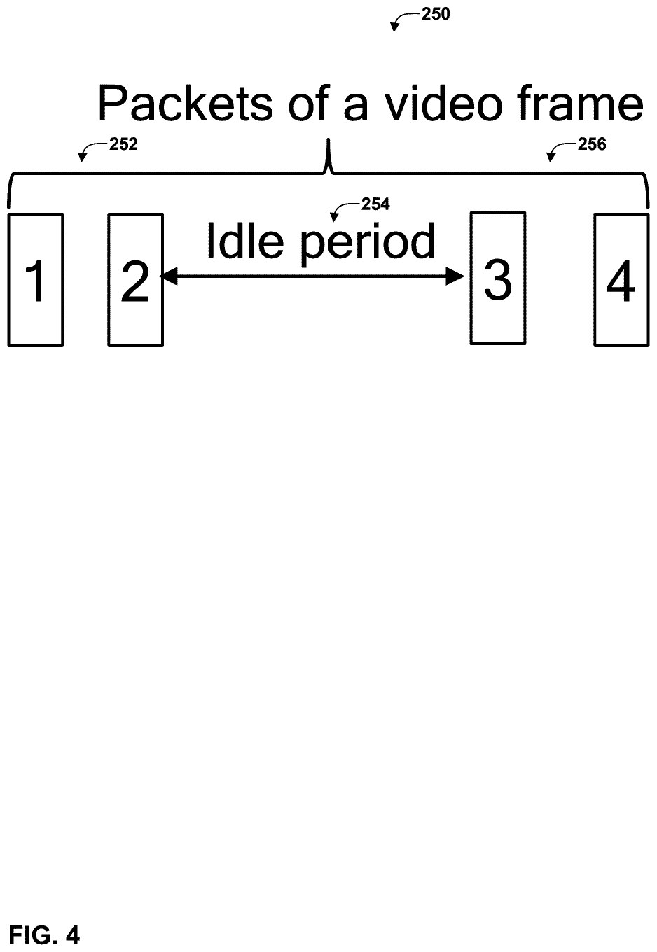

FIG. 4 is a conceptual diagram illustrating another example definition for an idle period per techniques of this disclosure. In this example, idle period 254 occurs between first set of packets 252 and second set of packets 256 of video frame 250 of video data. Each packet may correspond to, for example, a slice of the frame. In this case, idle period 254 exists between the ordinal second packet and the ordinal third packet of video frame 250 of video data. If a sending device (e.g., server device 60 of FIG. 1) creates a large time gap between two packets of a common video frame due to packet pacing triggered by rate control, the sending device can indicate the time gap as idle period 254, even though packets 250 may be considered as a protocol data unit (PDU) Set of a data burst. The ordinal first packet of video frame 250 can indicate idle period 254 and the time gap to the ordinal second packet of video frame 250 for improved error resilience.

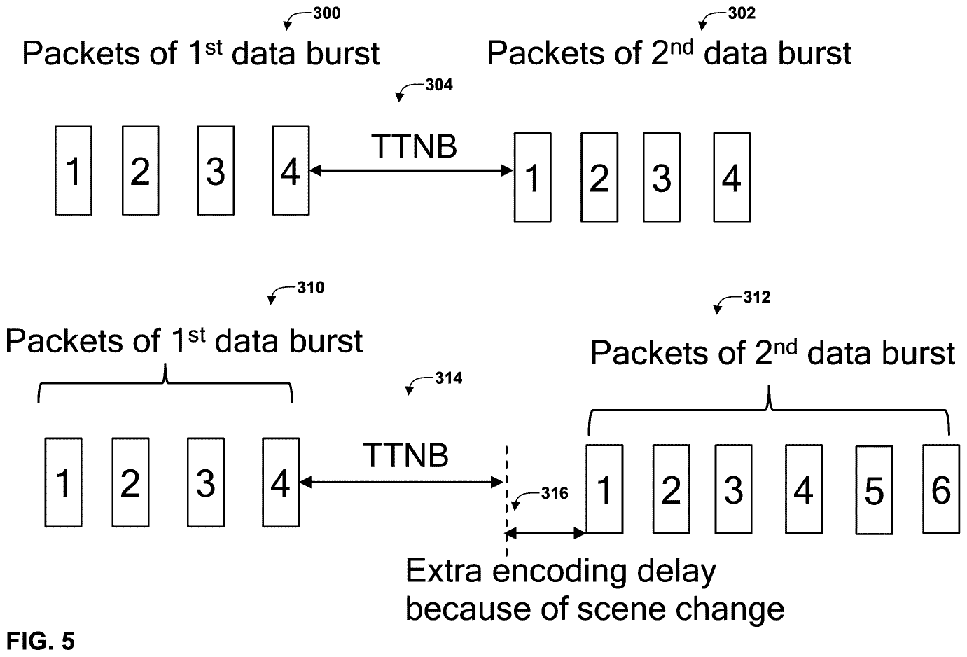

FIG. 5 is a conceptual diagram illustrating another example definition of an idle period per techniques of this disclosure. In this example, time to next burst (TTNB) is defined as a minimum or a lower bound on the time between data bursts (that is, between a last packet of a current data burst and a first packet of a next data burst), rather than a precise time between data bursts. In some examples, per the techniques of this disclosure, the TTNB value may represent a time interval between transmission of an ordinal last protocol data unit (PDU) in a current data burst and a time instant that is earlier than or equal to the transmission of an ordinal first PDU of a next data burst. FIG. 5 depicts an example of a set of packets of first data burst 300, a set of packets of second data burst 302, and TTNB 304. FIG. 5 also depicts an example set of packets of first data burst 310, an example set of packets of second data burst 312, TTNB 314, and extra amount of time 316.

A client device can disable reception (e.g., be put into sleep) during TTNB 304 and TTNB 314, then resume reception (wake up) at the end of TTNB 304, 314, even if there is an extra amount of time 316 until the subsequent packet of the next data burst. In some examples, one or more packets before packet 4 in first data burst 300, 310 may carry TTNB data, and the respective time gaps to the ordinal last packet of first data burst 300, 310, and this allows an intermediate router (e.g., base station) to determine when the current data burst ends and when the TTNB starts if the last packet of the first data burst is lost. In some examples, when the timing of the next data burst is deterministically known to the traffic source at the time of indication, TTNB 304, 314 may be the precise time between adjacent data bursts (e.g., packets of first data burst 300, 310 and packets of second data burst 302, 312).

In some examples, the idle period (or redefined TTNB value) may be signaled in a real-time transport protocol (RTP) header extension of a previous packet. That is, the RTP header extension may be included in an RTP packet and include data representing a minimum or a lower bound on the time between transmission of the RTP packet and transmission of a subsequent packet of the same packet flow. In some examples, the RTP header extension may be a dedicated RTP header extension that only conveys the idle period. In some examples, the RTP extension header may be an existing RTP header extension, e.g., an RTP header extension that conveys data concerning PDU Set marking, e.g., for data burst marking. For instance, the RTP header extension may correspond to the PDU Set marking extension defined in 3GPP Technical Specification (TS) 26.522. In such instances, the idle period data may be carried within the existing fields or extension fields of the PDU Set marking header. In some examples, the idle period indication may also indicate an end of the current data unit. In some examples, the idle period indication may be separate from the indication of the end of the data unit, e.g., the RTP header extension may include separate values for the idle period and the end of the data unit.

In some examples, a redundant indication of the starting point of the idle period may be sent. From the perspective of the traffic source, the starting point of the idle period may be the time instant when the packet that carries the idle period is transmitted by the traffic source. This packet may be lost. In this case, the base station will not be able to determine when the UE needs to go to sleep. With the notion of data burst, the base station is not able to determine when the data burst ends. To increase error resilience, the timing of the starting point may be indicated by multiple packets. For example, the packets before the lost packet noted above may indicate relative timing (respective time gaps) to the packet that is lost, e.g., the packet marked “4” in FIG. 5. In the case where multiple packets carry the TTNB value, these packets before the lost packet may also indicate respective time gaps to the last packet of the current data burst.

For example, any or all of packets 1-3 may include time gap data indicating time gaps to the end of packet 4, e.g., the end of the current burst. In this manner, if packet 4 is lost, using the arrival time of packet 3 and the time gap indicated in packet 3, the base station can determine the starting time of the idle period, such that the UE device can go to sleep and disable reception circuitry. Thus, if packet 4 is lost, using the arrival time of packet 3 and the time gap indicated in packet 3, the base station can determine the starting time of the TTNB and when the UE can go to sleep, e.g., disable reception circuitry.

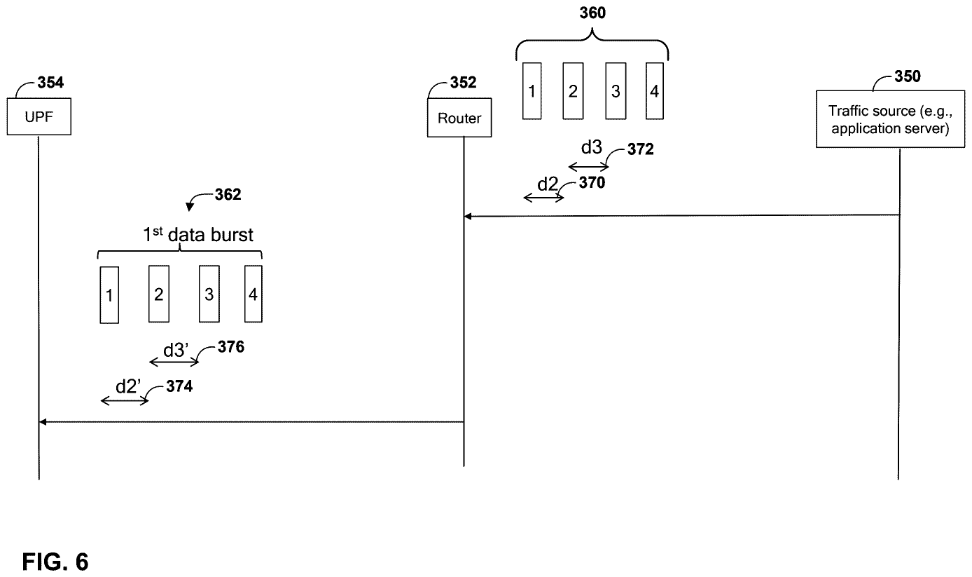

FIG. 6 is a conceptual diagram illustrating transmission of packets from a traffic source (e.g., application server (AS) device 350), a routing device, and a user plane function (UPF) device 354. UPF device 354 may be configured to encapsulate packets to form tunneled packets, such as GPRS tunneling protocol user data (GTP-U) packets that are sent to a base station (e.g., eNodeB or gNodeB) via a network tunnel.

AS device 350 may form an RTP header extension for packets 1-4 indicating the minimum or a lower bound on the time of transmission between the packets, e.g., an idle period and the time gap to the start of the idle period, per techniques of this disclosure. UPF device 354 may copy the idle period data and the time gap from the RTP header extensions into a GTP-U header of the GTP-U packets that encapsulate the RTP packets. In some examples, UPF device 354 may measure network jitter for a network path from AS device 350 to UPF device 354 and adjust the idle period according to the network jitter. That is, UPF device 354 may form the GTP-U header to include an adjusted idle period according to the signaled idle period in the RTP header extension and the measured network jitter.

In examples where the network is a 5G network, a network path from AS device 350 to UPF device 354 may include an N6 interface. Accordingly, UPF device 354 may measure the jitter associated with the N6 interface (N6 jitter) and adjust the signaled idle period or TTNB value to account for this interface-specific jitter before forwarding the packet to the base station.

In some examples, the packet immediately before the idle period is received, the base station may use the indicated idle period to configure the UE to go to sleep to stop data reception and to wake up at a configured time to resume data reception. In some examples, the packet immediately before the idle period is lost and a packet before the lost packet indicates the idle period and a time gap to the lost packet. In such examples, the base station may use the indicated idle period and the time gap to derive the start time of the idle period and tell the UE when to sleep to pause data reception and when to wake up to resume data reception.

To measure the network jitter, initially, AS device 350 may add an RTP header extension including a timestamp indicating the time of departure of the corresponding RTP packet. The RTP header extension may be of type “RTP header extension for absolute sender time.” The timestamp may be visible to intermediate routers when the RTP header extension is not encrypted. Thus, router 352 may compute the differences of the timestamps of multiple arriving RTP packets, as well as differences between actual arrival times of the RTP packets. Router 352 (or UPF device 354, which may also be a routing device) may then compare these differences to determine the network jitter. When a time gap is indicated along with an idle period or a TTNB, the time gap can be used to derive the network jitter by comparing the observed time gaps and the indicated time gaps.

As shown in FIG. 6, the time between transmission of packet 1 and packet 2 of first data burst 360 from AS device 350 to router 352 is represented as d2 370, and the time between transmission of packet 2 and packet 3 of first data burst 360 from AS device 350 to router 352 is represented as d3 372. Likewise, the time between transmission of packet 1 and packet 2 of first data burst 362 from router 352 to UPF device 354 is represented as d2′ 374, and the time between transmission of packet 2 and packet 3 of first data burst 362 from router 352 to UPF device 354 is represented as d3′ 376.

To calculate d2 370, UPF device 354 may calculate differences between timestamps of packets 1 and 2 indicating times of transmission of packets 1 and 2. To calculate d3 372, UPF device 354 may calculate differences between timestamps of packets 2 and 3 indicating times of transmission of packets 2 and 3. To calculate d2′ 374, UPF device 354 may calculate differences between times of reception of packets 1 and 2. To calculate d3′ 376, UPF device 354 may calculate differences between times of reception of packets 2 and 3. Per techniques of this disclosure, UPF device 354 may calculate network jitter according to d2-d2′, d3-d3′, and so on.

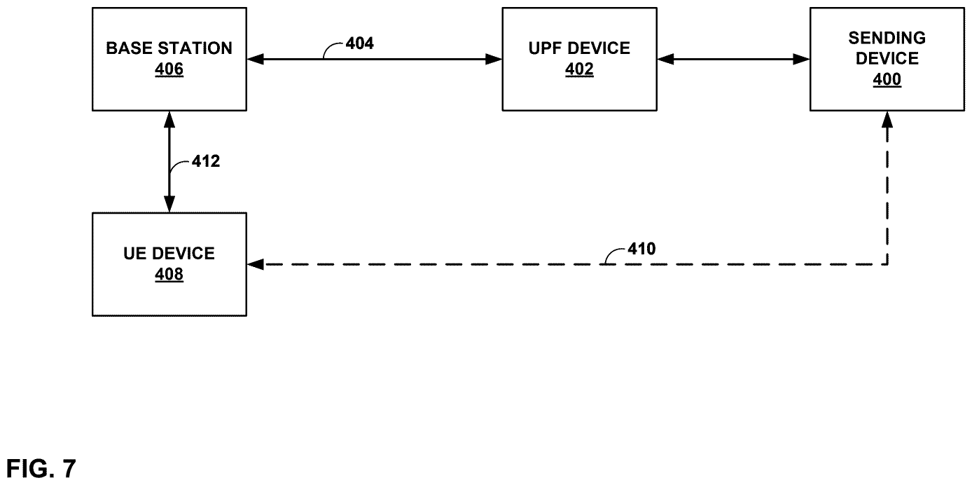

FIG. 7 is a block diagram illustrating an example set of network devices that may perform various aspects of the techniques of this disclosure. The example of FIG. 7 depicts sending device 400, user plane function (UPF) device 402, base station 406, and user equipment (UE) device 408. Sending device 400 may correspond to server device 60 and/or content preparation device 20 of FIG. 1. UE device 408 may correspond to client device 40 of FIG. 1.

Sending device 400 (e.g., an application server (AS) device) may obtain video data to be sent to UE device 408 via communication session 410. To send the video data to UE device 408, sending device 400 may encode the video data (or receive encoded video data from an encoding device, not shown in FIG. 7). Sending device 400 may encapsulate packets including encoded video data (e.g., encoded slices of frames of video data) to form real-time transport protocol (RTP) packets. Sending device 400 may add an RTP extension header to the RTP packets, where the RTP extension header includes data representing an idle period indicating a minimum or a lower bound on the time between a time of transmission of a current RTP packet and a time of transmission of a subsequent RTP packet. As the RTP packets are formed, sending device 400 may send the RTP packets to UE device 408 via a network including UPF device 402. Although not shown in FIG. 7, there may be additional network devices between sending device 400 and UPF device 402, e.g., various network routing devices, gateways, bridges, switches, or the like.

In some examples, sending device 400 may attempt to minimize the time gap between the calculated time instant (the end of the signaled idle period) and the actual transmission of the first packet of the subsequent data burst. By making the signaled idle period as large as possible without exceeding the actual time to the next burst, sending device 400 maximizes the duration for which UE device 408 may disable reception circuitry, thereby maximizing power savings while maintaining reliability.

In accordance with the techniques of this disclosure, sending device 400 may determine the idle period (or TTNB) as a time interval between transmission of an ordinal last packet (or PDU) of the current data burst and a time instant that is earlier than or equal to the expected time of transmission of an ordinal first packet (or PDU) of a subsequent data burst. By selecting a time instant that acts as a lower bound in this manner, sending device 400 may account for potential variability in the generation or encoding of the next data burst (e.g., video encoding delays) and/or network jitter. Sending device 400 may signal this lower bound to ensure that downstream devices, such as base station 406 and UE device 408, do not expect the subsequent burst to arrive earlier than the subsequent burst can be generated, while acknowledging that the actual arrival may occur after this minimum period.

UPF device 402 may receive the RTP packets from sending device 400 and form GTP-U tunneled packets. For example, UPF device 402 may encapsulate the RTP packets with respective GTP-U headers. Per techniques of this disclosure, UPF device 402 may extract the minimum or a lower bound on the time value from the RTP header extensions of the RTP packets and timestamps indicating times at which the RTP packets were transmitted by sending device 400, e.g., from respective RTP header extensions. UPF device 402 may also compare differences between the timestamps to differences between times of reception of the packets to measure network jitter. UPF device 402 may then form the GTP-U headers to include a modified idle period time according to the signaled minimum or a lower bound on the time values and the network jitter. UPF device 402 may send the GTP-U packets to base station 406 via network tunnel 404. Network tunnel 404 may include other network devices, such as network routing devices, configured to forward the GTP-U packets along network tunnel 404 to base station 406.

Base station 406 may receive the GTP-U packets and decapsulate the GTP-U packets to reproduce the RTP packets. Base station 406 may extract the data representing the minimum or lower bound on the time to the next data burst to optimize radio resource allocation. For example, base station 406 may interpret the signaled idle period as a guaranteed “quiet” interval during which no packets of communication session 410 will arrive. Consequently, base station 406 may schedule other traffic or allow discontinuous reception (DRX) cycles for UE device 408 during this interval, while ensuring that radio resources are scheduled to be available again after the expiration of the lower bound time period to receive packets of the subsequent data burst. Base station 406 may allocate resources to reception of the GTP-U packets based on the modified idle time period. Base station 406 may then send the RTP packets to UE device 408 via radio access network (RAN) connection 412.

UE device 408 may receive the RTP packets from base station 406 via RAN connection 412. In particular, UE device 408 may be a battery powered device, such as a cellphone. Thus, to preserve battery power, UE device 408 may disable reception of packets for communication session 410 via RAN connection 412 for idle period times indicated by the minimum or a lower bound on the time between a time of transmission of a previous packet and a time of transmission of a subsequent packet of communication session 410. For example, during the idle period times, UE device 408 may power down reception circuitry, then power up the reception circuitry at the end of the idle period.

Because the idle period represents a lower bound, base station 406 may configure UE device 408 to cause reception circuitry of UE device 408 to re-enable reception at the end of the indicated idle period. This may ensure that UE device 408 is active at the time that is earlier than or equal to the transmission of the first packet of the subsequent data burst. Through re-enabling reception at this lower bound time, UE device 408 may be ready to receive the subsequent packet/data burst, regardless of the actual encoding delay or network jitter, which may reduce battery power consumption by UE device 408 while also preventing packet loss that might otherwise occur if UE device 408 were to have disabled reception circuitry past the minimum expected arrival time.

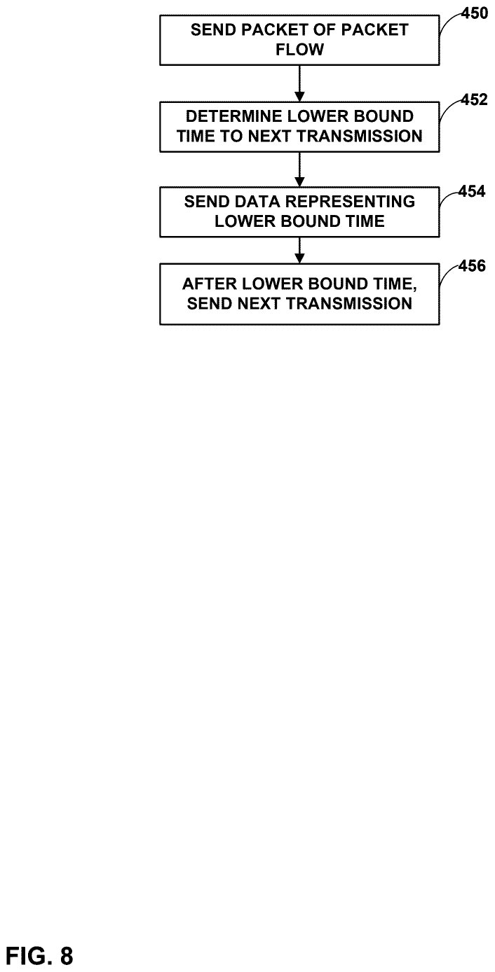

FIG. 8 is a flowchart illustrating an example method of sending media data via a network according to the techniques of this disclosure. In particular, FIG. 8 depicts an example of a method of sending a time to next burst (TTNB) value, that is, a lower bound on a time to a subsequent transmission (e.g., a subsequent set of packets for a subsequent video frame, a subsequent set of packets for a subsequent data burst, a subsequent packet of a current frame/data burst, or the like) according to the techniques of this disclosure. Sending device 400 of FIG. 7, server device 60 of FIG. 1, or other such devices may perform the method of FIG. 8. For purposes of example, the method of FIG. 8 is described with respect to sending device 400 of FIG. 7.

Initially, sending device 400 sends a packet of a packet flow (450). In some examples, sending device 400 sends the packet as an ordinal last packet of a current data burst. In some examples, sending device 400 sends the packet as an ordinal last packet of a current video frame. Sending device 400 then determines a lower bound on a time to a next transmission (452). Sending device 400 may calculate the lower bound as a minimum time duration that will elapse before sending device 400 transmits a subsequent packet (e.g., an ordinal first packet of a next data burst). Sending device 400 may determine this lower bound based on a frame rate of the media data and a variable encoding delay, e.g., associated with video encoder 28 (FIG. 1). For instance, sending device 400 may calculate the lower bound to be a time instant earlier than or equal to the transmission of the first protocol data unit (PDU) of the next data burst, ensuring that the actual transmission of the next data burst does not occur prior to this time instant.

Sending device 400 sends data representing the lower bound on the time (454). Sending device 400 may signal the data representing the lower bound in a header extension of the packet sent in step 450, such as a real-time transport protocol (RTP) header extension. This data may indicate to a receiving device (e.g., base station 406 and/or UE device 408) a guaranteed idle period during which sending device 400 will not transmit data for the packet flow.

After an amount of time corresponding to the lower bound on the time to the next transmission (e.g., a time corresponding to the TTNB) has elapsed, sending device 400 sends data of the next transmission (456). Sending device 400 waits until the expiration of an amount of time equal to the signaled lower bound on the time before transmitting the subsequent packet (e.g., the first packet of the next data burst). By adhering to this lower bound, sending device 400 may ensure that UE device 408, which may have disabled reception circuitry (e.g., of network interface 54) to save power during the idle period, has enabled reception circuitry in time to receive the next transmission. Sending device 400 may transmit the next transmission at a time equal to or later than the time instant defined by the lower bound.

In this manner, the method of FIG. 8 represents an example of a method of sending data via a network, including determining a lower bound on a time between a time of transmission of the previous packet and a time of transmission of a subsequent packet of the packet flow; sending data representing the lower bound on the time between the time of transmission of the previous packet and the time of transmission of the subsequent packet to the client device; and at or after a time corresponding to the lower bound on the time following the time of transmission of the previous packet, sending the subsequent packet to the client device.

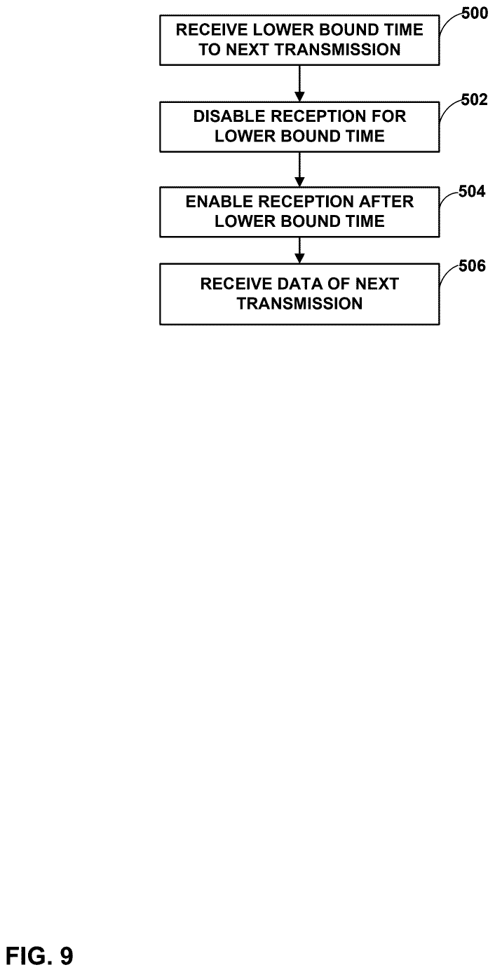

FIG. 9 is a flowchart illustrating an example method of receiving media data via a network according to the techniques of this disclosure. The method of FIG. 9 may be performed by a receiving device, such as client device 40 of FIG. 1, or user equipment (UE) device 408 or base station 406 of FIG. 7.

The receiving device receives data representing a lower bound on a time between a time of transmission of a previous packet and a time of transmission of a subsequent packet (500). The receiving device may receive the data representing the lower bound from a sending device, such as server device 60 of FIG. 1 or sending device 400 of FIG. 7. In some examples, the data representing the lower bound includes data defining an idle time period during which the sending device will not transmit data. In some examples, the data representing the lower bound comprises data defining a time to next burst (TTNB) value. The TTNB value may represent a time instant that is earlier than or equal to the transmission of the first protocol data unit (PDU) of the next data burst.

In examples where the receiving device is UE device 408, UE device 408 may receive the data representing the lower bound from base station 406. Alternatively, base station 406 may receive the data representing the lower bound (e.g., from server device 60 via user plane function (UPF) device 402) and configure UE device 408 to enable or disable reception based on the data. In some examples, the receiving device receives the data representing the lower bound in a real-time transport protocol (RTP) header extension of the previous packet. The RTP header extension may further include protocol data unit (PDU) set marking data. In some examples, the data representing the lower bound is separate from data representing an end of a data unit (e.g., a marker bit).

After receiving the previous packet, the receiving device disables reception of data for an idle time period according to the data representing the lower bound on the time between the time of transmission of the previous packet and the time of transmission of the subsequent packet (502). For example, UE device 408 may transition reception circuitry of network interface 54 (e.g., a radio receiver) into a low-power or sleep state to conserve battery power. The previous packet may correspond to an ordinal last packet of a current frame of video data, and the subsequent packet may correspond to an ordinal first packet of a subsequent frame of the video data. Alternatively, the previous packet and the subsequent packet may belong to a common frame of video data (e.g., separate slices), where the subsequent packet corresponds to a second, different packet of the current frame transmitted after a delay.

After the idle time period, the receiving device enables reception of data (504). The receiving device activates reception circuitry of network interface 54 at or before the expiration of the time defined by the lower bound. By enabling reception at the time corresponding to the lower bound, the receiving device ensures readiness to receive the subsequent packet even if the subsequent packet arrives earlier than a maximum possible delay but later than the minimum guaranteed idle time.

After enabling reception of data, the receiving device receives the subsequent packet (506). In some examples, because the signaled time is a lower bound, the receiving device may receive the subsequent packet at a time later than the time at which the receiving device enables reception of data following the idle time period. This timing buffer accounts for variable encoding delays (e.g., due to scene changes) or network jitter, ensuring the receiving device does not miss the start of the next data burst while still maximizing the duration of the low-power state.

Various examples of the techniques of this disclosure are summarized in the following clauses:

Clause 1: A method of receiving data via a network, the method comprising: receiving data representing a minimum or lower bound on a time between a time of transmission of a previous packet and a time of transmission of a subsequent packet; after receiving the previous packet, disabling reception of data for an idle time period according to the data representing the minimum or lower bound on the time between the time of transmission of the previous packet and the time of transmission of the subsequent packet; after the idle time period, enabling reception of data; and after enabling reception of data, receiving the subsequent packet.

Clause 2: The method of clause 1, wherein the data representing the minimum or lower bound on the time between the time of transmission of the previous packet and the time of transmission of the subsequent packet comprises data defining the idle time period.

Clause 3: The method of clause 1, wherein the data representing the minimum or lower bound on the time between the time of transmission of the previous packet and the time of transmission of the subsequent packet comprises data defining a time to next burst (TTNB) value.

Clause 4: The method of any of clauses 1-3, wherein receiving comprises receiving, by a base station, the method further comprising causing a user equipment (UE) device to enable reception of data after the idle time period.

Clause 5: The method of any of clauses 1-3, wherein receiving the data representing the minimum or lower bound comprises receiving, by a user equipment (UE) device, from a base station.

Clause 6: The method of any of clauses 1-5, wherein receiving the subsequent packet comprises receiving the subsequent packet at a time later than the time at which reception of data is enabled following the idle time period.

Clause 7: The method of any of clauses 1-6, wherein the previous packet corresponds to a last packet of a current frame of video data, and the subsequent packet corresponds to a first packet of a subsequent frame of the video data.

Clause 8: The method of any of clauses 1-6, wherein the subsequent packet corresponds to a first packet of a current frame of video data, and the subsequent packet corresponds to a second, different packet of the current frame of the video data.

Clause 9: The method of any of clauses 1-8, wherein receiving the data representing the minimum or lower bound on the time between the time of transmission of the previous packet and the time of transmission of the subsequent packet comprises receiving a real-time transport protocol (RTP) header extension including the data representing the minimum or lower bound on the time between the time of transmission of the previous packet and the time of transmission of the subsequent packet.

Clause 10: The method of clause 9, wherein the RTP header extension further includes protocol data unit (PDU) set marking data.

Clause 11: The method of any of clauses 1-10, wherein the data representing the minimum or lower bound on the time between the time of transmission of the previous packet and the time of transmission of the subsequent packet also represents an end of a data unit.

Clause 12: The method of any of clauses 1-10, wherein the data representing the minimum or lower bound on the time between the time of transmission of the previous packet and the time of transmission of the subsequent packet is separate from data representing an end of a data unit.

Clause 13: The method of any of clauses 1-12, wherein the method is performed by a user plane function (UPF) device, the method further comprising: encapsulating the previous packet in a GPRS tunneling protocol user data (GTP-U) packet including a GTP-U header including the data representing the minimum or lower bound on the time between the time of transmission of the previous packet and the time of transmission of the subsequent packet; and forwarding the GTP-U encapsulated subsequent packet.

Clause 14: The method of any of clauses 1-12, wherein the method is performed by a user plane function (UPF) device, the method further comprising: measuring network jitter along a network path for a packet flow including the previous packet and the subsequent packet; encapsulating the previous packet in a GPRS tunneling protocol user data (GTP-U) packet including a GTP-U header including an adjusted time to next burst (TTNB) value, the adjusted TTNB value corresponding to the data representing the minimum or lower bound on the time between the time of transmission of the previous packet and the time of transmission of the subsequent packet adjusted according to the network jitter; and forwarding the GTP-U encapsulated subsequent packet.

Clause 15: The method of clause 14, further comprising: extracting a timestamp from an RTP header extension of the previous packet, the timestamp indicating a time of departure of the previous packet; and extracting timestamps from prior RTP header extensions of packets earlier than the previous packet of the packet flow, wherein measuring the network jitter comprises calculating differences between the timestamps and differences between arrival times of the previous packet and the packets earlier than the previous packet.

Clause 16: The method of clause 14, further comprising: extracting a time gap from an RTP header extension of the previous packet; and measuring a first difference between the previous packet and a packet earlier than the previous packet of the packet flow, wherein measuring the network jitter comprises calculating differences between the time gap and the first difference.

Clause 17: A method of sending data via a network, the method comprising: sending a previous packet of a packet flow to a client device; determining a minimum time between a time of transmission of the previous packet and a time of transmission of a subsequent packet of the packet flow; sending data representing the minimum or lower bound on the time between the time of transmission of the previous packet and the time of transmission of the subsequent packet to the client device; and at or after a time corresponding to the minimum or lower bound on the time following the time of transmission of the previous packet, sending the subsequent packet to the client device.

Clause 18: The method of clause 17, wherein the data representing the minimum or lower bound on the time between the time of transmission of the previous packet and the time of transmission of the subsequent packet comprises data defining an idle time period.

Clause 19: The method of clause 17, wherein the data representing the minimum or lower bound on the time between the time of transmission of the previous packet and the time of transmission of the subsequent packet comprises data defining a time to next burst (TTNB) value.

Clause 20: The method of any of clauses 17-19, further comprising calculating the minimum or lower bound on the time between the time of transmission of the previous packet and the time of transmission of the subsequent packet according to a video encoding delay, wherein the previous packet includes encoded video data of a media presentation and the subsequent packet comprises encoded video data of the media presentation.

Clause 21: The method of clause 20, wherein calculating the minimum or lower bound on the time between the time of transmission of the previous packet and the time of transmission of the subsequent packet comprises determining that the video data of the previous packet corresponds to a first video scene and the video data of the subsequent packet corresponds to a second video scene when a scene change occurs between the first video scene and the second video scene.

Clause 22: The method of any of clauses 20 and 21, wherein the previous packet corresponds to a last packet of a current frame of video data, and the subsequent packet corresponds to a first packet of a subsequent frame of the video data.

Clause 23: The method of clause 20, wherein the subsequent packet corresponds to a first packet of a current frame of video data, and the subsequent packet corresponds to a second, different packet of the current frame of the video data.

Clause 24: The method of any of clauses 17-23, wherein sending the data representing the minimum or lower bound on the time between the time of transmission of the previous packet and the time of transmission of the subsequent packet comprises sending a real-time transport protocol (RTP) header extension including the data representing the minimum or lower bound on the time between the time of transmission of the previous packet and the time of transmission of the subsequent packet.

Clause 25: The method of clause 24, wherein the RTP header extension further includes protocol data unit (PDU) set marking data.

Clause 26: The method of any of clauses 17-25, wherein the data representing the minimum or lower bound on the time between the time of transmission of the previous packet and the time of transmission of the subsequent packet also represents an end of a data unit.

Clause 27: The method of any of clauses 17-25, wherein the data representing the minimum or lower bound on the time between the time of transmission of the previous packet and the time of transmission of the subsequent packet is separate from data representing an end of a data unit.

Clause 28: A device for receiving data via a network, the device comprising one or more means for performing the method of any of clauses 1-27.

Clause 29: The device of clause 28, wherein the one or more means comprise a memory and a processing system implemented in circuitry.

Clause 30: The device of clause 28, wherein the device comprises at least one of: an integrated circuit; a microprocessor; and a wireless communication device.

Clause 31: A device for retrieving media data, the device comprising: means for receiving data representing a minimum time or lower bound on a time between a time of transmission of a previous packet and a time of transmission of a subsequent packet; means for, after reception of the previous packet, disabling reception of data for an idle time period according to the data representing the minimum or lower bound on the time between the time of transmission of the previous packet and the time of transmission of the subsequent packet; means for, after the idle time period, enabling reception of data; and means for, after enabling reception of data, receiving the subsequent packet.

Clause 32: A device for sending data via a network, the device comprising: means for sending a previous packet of a packet flow to a client device; means for determining a minimum or lower bound on a time between a time of transmission of the previous packet and a time of transmission of a subsequent packet of the packet flow; means for sending data representing the minimum or lower bound on the time between the time of transmission of the previous packet and the time of transmission of the subsequent packet to the client device; and means for, at or after a time corresponding to the minimum or lower bound on the time following the time of transmission of the previous packet, sending the subsequent packet to the client device.

Clause 33. A method of receiving data via a network, the method comprising: receiving data representing a lower bound on a time between a time of transmission of a previous packet and a time of transmission of a subsequent packet; after receiving the previous packet, disabling reception of data for an idle time period according to the data representing the lower bound on the time between the time of transmission of the previous packet and the time of transmission of the subsequent packet; after the idle time period, enabling reception of data; and after enabling reception of data, receiving the subsequent packet.

Clause 34: The method of clause 33, wherein the data representing the lower bound on the time between the time of transmission of the previous packet and the time of transmission of the subsequent packet comprises data defining a time to next burst (TTNB) value.

Clause 35: The method of any of clauses 33-34, wherein receiving comprises receiving, by a base station, the method further comprising configuring a user equipment (UE) device to enable reception of data after the idle time period.

Clause 36: The method of any of clauses 33-34, wherein receiving the data representing the lower bound comprises receiving, by a user equipment (UE) device, the data from a base station.

Clause 37: The method of any of clauses 33-36, wherein receiving the subsequent packet comprises receiving the subsequent packet at a time later than the time at which reception of data is enabled following the idle time period.

Clause 38: The method of any of clauses 33-37, wherein the previous packet corresponds to an ordinal last packet of a current frame of video data, and the subsequent packet corresponds to an ordinal first packet of a subsequent frame of the video data.

Clause 39: The method of any of clauses 33-37, wherein the subsequent packet corresponds to an ordinal first packet of a current frame of video data, and the subsequent packet corresponds to a different packet of the current frame of the video data.

Clause 40: The method of any of clauses 33-39, wherein receiving the data representing the lower bound on the time between the time of transmission of the previous packet and the time of transmission of the subsequent packet comprises receiving a real-time transport protocol (RTP) header extension including the data representing the lower bound on the time between the time of transmission of the previous packet and the time of transmission of the subsequent packet.

Clause 41: The method of clause 40, wherein the RTP header extension further includes protocol data unit (PDU) set marking data.

Clause 42: The method of any of clauses 33-41, wherein the data representing the lower bound on the time between the time of transmission of the previous packet and the time of transmission of the subsequent packet is separate from data representing an end of a data unit.

Clause 43: The method of any of clauses 33-42, wherein the method is performed by a user plane function (UPF) device, the method further comprising: measuring network jitter along a network path for a packet flow including the previous packet and the subsequent packet; encapsulating the previous packet in a GPRS tunneling protocol user data (GTP-U) packet including a GTP-U header including an adjusted time to next burst (TTNB) value, the adjusted TTNB value corresponding to the data representing the lower bound on the time between the time of transmission of the previous packet and the time of transmission of the subsequent packet adjusted according to the network jitter; and forwarding the GTP-U encapsulated subsequent packet.

Clause 44: The method of clause 43, further comprising: extracting a timestamp from an RTP header extension of the previous packet, the timestamp indicating a time of departure of the previous packet; and extracting timestamps from prior RTP header extensions of packets earlier than the previous packet of the packet flow, wherein measuring the network jitter comprises calculating differences between the timestamps and differences between arrival times of the previous packet and the packets earlier than the previous packet.

Clause 45: The method of clause 43, further comprising: extracting a time gap from an RTP header extension of the previous packet; and measuring a first difference between the previous packet and a packet earlier than the previous packet of the packet flow, wherein measuring the network jitter comprises calculating differences between the time gap and the first difference.

Clause 46: A device for receiving data via a network, the device comprising: a memory configured to store media data; and a processing system implemented in circuitry, the processing system comprising reception circuitry configured to receive packets including media data and one or more processors implemented in circuitry, the processing system being configured to: receive, via the reception circuitry, data representing a lower bound on a time between a time of transmission of a previous packet and a time of transmission of a subsequent packet; after receiving the previous packet, disable the reception circuitry for an idle time period according to the data representing the lower bound on the time between the time of transmission of the previous packet and the time of transmission of the subsequent packet; after the idle time period, enable the reception circuitry; and after enabling the reception circuitry, receive, via the reception circuitry, the subsequent packet.

Clause 47: A method of sending data via a network, the method comprising: sending a previous packet of a packet flow to a client device; determining a minimum time between a time of transmission of the previous packet and a time of transmission of a subsequent packet of the packet flow; sending data representing the lower bound on the time between the time of transmission of the previous packet and the time of transmission of the subsequent packet to the client device; and at or after a time corresponding to the lower bound on the time following the time of transmission of the previous packet, sending the subsequent packet to the client device.

Clause 48: The method of clause 47, wherein the data representing the lower bound on the time between the time of transmission of the previous packet and the time of transmission of the subsequent packet comprises data defining an idle time period.

Clause 49: The method of clause 47, wherein the data representing the lower bound on the time between the time of transmission of the previous packet and the time of transmission of the subsequent packet comprises data defining a time to next burst (TTNB) value.

Clause 50: The method of any of clauses 47-49, further comprising calculating the lower bound on the time between the time of transmission of the previous packet and the time of transmission of the subsequent packet according to a video encoding delay, wherein the previous packet includes encoded video data of a media presentation and the subsequent packet comprises encoded video data of the media presentation.

Clause 51: The method of clause 50, wherein calculating the lower bound on the time between the time of transmission of the previous packet and the time of transmission of the subsequent packet comprises determining that the video data of the previous packet corresponds to a first video scene and the video data of the subsequent packet corresponds to a second video scene when a scene change occurs between the first video scene and the second video scene.

Clause 52: The method of any of clauses 50 and 51, wherein the previous packet corresponds to a last packet of a current frame of video data, and the subsequent packet corresponds to a first packet of a subsequent frame of the video data.

Clause 53: The method of clause 50, wherein the subsequent packet corresponds to a first packet of a current frame of video data, and the subsequent packet corresponds to a second, different packet of the current frame of the video data.

Clause 54: The method of any of clauses 47-53, wherein sending the data representing the lower bound on the time between the time of transmission of the previous packet and the time of transmission of the subsequent packet comprises sending a real-time transport protocol (RTP) header extension including the data representing the lower bound on the time between the time of transmission of the previous packet and the time of transmission of the subsequent packet.

Clause 55: The method of clause 54, wherein the RTP header extension further includes protocol data unit (PDU) set marking data.

Clause 56: The method of any of clauses 47-55, wherein the data representing the lower bound on the time between the time of transmission of the previous packet and the time of transmission of the subsequent packet also represents an end of a data unit.

Clause 57: The method of any of clauses 47-55, wherein the data representing the lower bound on the time between the time of transmission of the previous packet and the time of transmission of the subsequent packet is separate from data representing an end of a data unit.

Clause 58: The method of any of clauses 47-57, wherein the method is performed by a user plane function (UPF) device, the method further comprising: measuring network jitter along a network path for a packet flow including the previous packet and the subsequent packet; encapsulating the previous packet in a GPRS tunneling protocol user data (GTP-U) packet including a GTP-U header including an adjusted time to next burst (TTNB) value to form a GTP-U encapsulated previous packet, the adjusted TTNB value corresponding to the data representing the lower bound on the time between the time of transmission of the previous packet and the time of transmission of the subsequent packet adjusted according to the network jitter; and forwarding the GTP-U encapsulated previous packet.

Clause 59: The method of clause 58, further comprising: extracting a timestamp from an RTP header extension of the previous packet, the timestamp indicating a time of departure of the previous packet; and extracting timestamps from prior RTP header extensions of packets earlier than the previous packet of the packet flow, wherein measuring the network jitter comprises calculating differences between the timestamps and differences between arrival times of the previous packet and the packets earlier than the previous packet.

Clause 60: The method of clause 58, further comprising: extracting a time gap from an RTP header extension of the previous packet; and measuring a first difference between the previous packet and a packet earlier than the previous packet of the packet flow, wherein measuring the network jitter comprises calculating differences between the time gap and the first difference.

Clause 61: A device for receiving data via a network, the device comprising one or more means for performing the method of any of clauses 33-60.

Clause 62: The device of clause 61, wherein the one or more means comprise a memory and a processing system implemented in circuitry.

Clause 63: The device of clause 61, wherein the device comprises at least one of: an integrated circuit; a microprocessor; and a wireless communication device.

Clause 64: A device for retrieving media data, the device comprising: means for receiving data representing a minimum time or lower bound on a time between a time of transmission of a previous packet and a time of transmission of a subsequent packet; means for, after reception of the previous packet, disabling reception of data for an idle time period according to the data representing the lower bound on the time between the time of transmission of the previous packet and the time of transmission of the subsequent packet; means for, after the idle time period, enabling reception of data; and means for, after enabling reception of data, receiving the subsequent packet.

Clause 65: A device for sending data via a network, the device comprising: means for sending a previous packet of a packet flow to a client device; means for determining a lower bound on a time between a time of transmission of the previous packet and a time of transmission of a subsequent packet of the packet flow; means for sending data representing the minimum or lower bound on the time between the time of transmission of the previous packet and the time of transmission of the subsequent packet to the client device; and means for, at or after a time corresponding to the minimum or lower bound on the time following the time of transmission of the previous packet, sending the subsequent packet to the client device.

In one or more examples, the functions described may be implemented in hardware, software, firmware, or any combination thereof. If implemented in software, the functions may be stored on or transmitted over as one or more instructions or code on a computer-readable medium and executed by a hardware-based processing unit. Computer-readable media may include computer-readable storage media, which corresponds to a tangible medium such as data storage media, or communication media including any medium that facilitates transfer of a computer program from one place to another, e.g., according to a communication protocol. In this manner, computer-readable media generally may correspond to (1) tangible computer-readable storage media which is non-transitory or (2) a communication medium such as a signal or carrier wave. Data storage media may be any available media that can be accessed by one or more computers or one or more processors to retrieve instructions, code, and/or data structures for implementation of the techniques described in this disclosure. A computer program product may include a computer-readable medium.

By way of example, and not limitation, such computer-readable storage media can comprise RAM, ROM, EEPROM, CD-ROM or other optical disk storage, magnetic disk storage, or other magnetic storage devices, flash memory, or any other medium that can be used to store desired program code in the form of instructions or data structures and that can be accessed by a computer. Also, any connection is properly termed a computer-readable medium. For example, if instructions are transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of medium. It should be understood, however, that computer-readable storage media and data storage media do not include connections, carrier waves, signals, or other transitory media, but are instead directed to non-transitory, tangible storage media. Disk and disc, as used herein, includes compact disc (CD), laser disc, optical disc, digital versatile disc (DVD), floppy disk and Blu-ray disc where disks usually reproduce data magnetically, while discs reproduce data optically with lasers. Combinations of the above should also be included within the scope of computer-readable media.

Instructions may be executed by one or more processors, such as one or more digital signal processors (DSPs), general purpose microprocessors, application specific integrated circuits (ASICs), field programmable logic arrays (FPGAs), or other equivalent integrated or discrete logic circuitry. Accordingly, the term “processor,” as used herein may refer to any of the foregoing structure or any other structure suitable for implementation of the techniques described herein. In addition, in some aspects, the functionality described herein may be provided within dedicated hardware and/or software modules configured for encoding and decoding, or incorporated in a combined codec. Also, the techniques could be fully implemented in one or more circuits or logic elements.

The techniques of this disclosure may be implemented in a wide variety of devices or apparatuses, including a wireless handset, an integrated circuit (IC) or a set of ICs (e.g., a chip set). Various components, modules, or units are described in this disclosure to emphasize functional aspects of devices configured to perform the disclosed techniques, but do not necessarily require realization by different hardware units. Rather, as described above, various units may be combined in a codec hardware unit or provided by a collection of interoperative hardware units, including one or more processors as described above, in conjunction with suitable software and/or firmware.

Various examples have been described. These and other examples are within the scope of the following claims.

What is claimed is:

1. A method of receiving data via a network, the method comprising:
receiving data representing a lower bound on a time between a time of transmission of a previous packet and a time of transmission of a subsequent packet;
after receiving the previous packet, disabling reception of data for an idle time period according to the data representing the lower bound on the time between the time of transmission of the previous packet and the time of transmission of the subsequent packet;
after the idle time period, enabling reception of data; and
after enabling reception of data, receiving the subsequent packet.

2. The method of claim 1, wherein the data representing the lower bound on the time between the time of transmission of the previous packet and the time of transmission of the subsequent packet comprises data defining a time to next burst (TTNB) value, the previous packet represents an ordinal last protocol data unit (PDU) of a current data burst, the subsequent packet comprises an ordinal first PDU of a next data burst, and the TTNB value represents the lower bound as a time interval between the time of transmission of the ordinal last PDU of the current data burst and a time instant that is earlier than or equal to the time of transmission of the ordinal first PDU of the next data burst.

3. The method of claim 1, wherein receiving comprises receiving, by a base station, the method further comprising configuring a user equipment (UE) device to enable reception of data after the idle time period.

4. The method of claim 1, wherein receiving the data representing the lower bound comprises receiving, by a user equipment (UE) device, the data from a base station.

5. The method of claim 1, wherein receiving the subsequent packet comprises receiving the subsequent packet at a time later than the time at which reception of data is enabled following the idle time period.

6. The method of claim 1, wherein the previous packet corresponds to an ordinal last packet of a current data burst, and the subsequent packet corresponds to an ordinal first packet of a subsequent data burst.

7. The method of claim 1, wherein the subsequent packet corresponds to an ordinal first packet of a current frame of video data, and the subsequent packet corresponds to a different packet of the current frame of the video data.

8. The method of claim 1, wherein receiving the data representing the lower bound on the time between the time of transmission of the previous packet and the time of transmission of the subsequent packet comprises receiving a real-time transport protocol (RTP) header extension including the data representing the lower bound on the time between the time of transmission of the previous packet and the time of transmission of the subsequent packet.

9. The method of claim 8, wherein the RTP header extension further includes protocol data unit (PDU) set marking data.

10. The method of claim 1, wherein the data representing the lower bound on the time between the time of transmission of the previous packet and the time of transmission of the subsequent packet is separate from data representing an end of a data unit.

11. A device for receiving media data via a network, the device comprising:
a memory configured to store media data; and
a processing system implemented in circuitry, the processing system comprising reception circuitry configured to receive packets including media data and one or more processors implemented in circuitry, the processing system being configured to:
receive, via the reception circuitry, data representing a lower bound on a time between a time of transmission of a previous packet and a time of transmission of a subsequent packet;
after receiving the previous packet, disable the reception circuitry for an idle time period according to the data representing the lower bound on the time between the time of transmission of the previous packet and the time of transmission of the subsequent packet;
after the idle time period, enable the reception circuitry; and
after enabling the reception circuitry, receive, via the reception circuitry, the subsequent packet.

12. A method of sending data via a network, the method comprising:
sending a previous packet of a packet flow to a client device;
determining a lower bound on a time between a time of transmission of the previous packet and a time of transmission of a subsequent packet of the packet flow;
sending data representing the lower bound on the time between the time of transmission of the previous packet and the time of transmission of the subsequent packet to the client device; and
at or after a time corresponding to the lower bound on the time following the time of transmission of the previous packet, sending the subsequent packet to the client device.

13. The method of claim 12, wherein the data representing the lower bound on the time between the time of transmission of the previous packet and the time of transmission of the subsequent packet comprises data defining a time to next burst (TTNB) value, the previous packet represents an ordinal last protocol data unit (PDU) of a current data burst, the subsequent packet comprises an ordinal first PDU of a next data burst, and the TTNB value represents the lower bound as a time interval between the time of transmission of the ordinal last PDU of the current data burst and a time instant that is earlier than or equal to the time of transmission of the ordinal first PDU of the next data burst.

14. The method of claim 12, further comprising calculating the lower bound on the time between the time of transmission of the previous packet and the time of transmission of the subsequent packet according to a video encoding delay, wherein the previous packet includes encoded video data of a media presentation and the subsequent packet comprises encoded video data of the media presentation.

15. The method of claim 14, wherein calculating the lower bound on the time between the time of transmission of the previous packet and the time of transmission of the subsequent packet comprises determining that the video data of the previous packet corresponds to a first video scene and the video data of the subsequent packet corresponds to a second video scene when a scene change occurs between the first video scene and the second video scene.

16. The method of claim 12, wherein sending the data representing the lower bound on the time between the time of transmission of the previous packet and the time of transmission of the subsequent packet comprises sending a real-time transport protocol (RTP) header extension including the data representing the lower bound on the time between the time of transmission of the previous packet and the time of transmission of the subsequent packet.

17. The method of claim 12, wherein the data representing the lower bound on the time between the time of transmission of the previous packet and the time of transmission of the subsequent packet is separate from data representing an end of a data unit.

18. The method of claim 12, wherein the method is performed by a user plane function (UPF) device, the method further comprising:
measuring network jitter along a network path for a packet flow including the previous packet and the subsequent packet;
encapsulating the previous packet in a GPRS tunneling protocol user data (GTP-U) packet including a GTP-U header including an adjusted time to next burst (TTNB) value to form a GTP-U encapsulated previous packet, the adjusted TTNB value corresponding to the data representing the lower bound on the time between the time of transmission of the previous packet and the time of transmission of the subsequent packet and determined according to the network jitter; and
forwarding the GTP-U encapsulated previous packet.

19. The method of claim 18, further comprising:
extracting a timestamp from an RTP header extension of the previous packet, the timestamp indicating a time of departure of the previous packet; and
extracting timestamps from prior RTP header extensions of packets earlier than the previous packet of the packet flow,
wherein measuring the network jitter comprises calculating differences between the timestamps and differences between arrival times of the previous packet and the packets earlier than the previous packet.

20. The method of claim 18, further comprising:
extracting a time gap from an RTP header extension of the previous packet; and
measuring a first difference between the previous packet and a packet earlier than the previous packet of the packet flow,
wherein measuring the network jitter comprises calculating differences between the time gap and the first difference.
